(19) United States
(12) Patent Application Publication
(10) Pub. No.: US 2024/0148140 A1
(43) Pub. Date: May 9, 2024

(54) DRAWER TRACK COMBINING EXTRUDED ALUMINUM PROFILES AND SPHERICAL BEARINGS, AND VEHICLE-MOUNTED STORAGE DRAWER THEREOF

(71) Applicant: Guanwen Wang, Chengdu (CN)

(72) Inventor: Guanwen Wang, Chengdu (CN)

(21) Appl. No.: 18/415,657

(22) Filed: Jan. 18, 2024

(30) Foreign Application Priority Data
Aug. 2, 2023 (CN) 202310966382.2

(51) Int. Cl. A47B 88/493

(52) U.S. Cl. CPC A47B 88/493; A47B 2210/0032

(57) ABSTRACT

The present disclosure relates to the technical field of vehicle-mounted movable drawers, and in particular, to a drawer track combining extruded aluminum profiles and spherical bearings, and a vehicle-mounted storage drawer. The drawer track includes a movable sliding rail plate and a bearing fixing plate which are mutually guided and are in sliding fit; the movable sliding rail plate and the bearing fixing plate are both made of extruded aluminum profiles; a hollow sliding rail is extruded and formed on one side of the movable sliding rail plate, and curved slideways are formed by inward sinking along an upper part and a lower part of the hollow sliding rail; the bearing fixing plate is rotatably connected with a plurality of outer spherical bearings corresponding to the curved slideways; the bearing fixing plate is extruded to form a thickened bar.

### TECHNICAL FIELD

The present disclosure relates to the technical field of vehicle-mounted movable drawers, and particularly, to a drawer track combining extruded aluminum profiles and spherical bearings, and a vehicle-mounted storage drawer thereof.

### BACKGROUND

With the improvement of the flexibility of storage during driving, during outdoor operations such as road trip that require a large number of items to be carried, a movable storage drawer would be arranged in a trunk of a vehicle. The draw can be pulled and pushed to take out and place items. During use of this product, an item is placed from a top of the product, which would not make it difficult to take out items inside. Furthermore, in the process of taking out and placing an item, the movable drawer can be pulled out to the back of the vehicle, making a user feel flexible and convenient to take out and place items. The existing vehicle-mounted movable storage drawer is basically mounted as an inseparable whole in a trunk of a vehicle, with a high precision requirement. In terms of structural design, consideration will be made to its strength, stability, ease of assembling, and durability. Due to a bumpy driving process, a traditional movable storage drawer is made of a high-strength metal plate. A galvanized plate bent profile is usually used to manufacture the structure of the movable storage drawer. However, bent profiles have process problems: a bending process causes a large tolerance. Self-assembling would greatly increase an error of matching between various plates, so that the pulling type structural design of this type of movable storage drawer is unstable, and a collision sound and other sounds are easily caused by the bumpiness during driving. Moreover, after the movable drawer is pulled out, a track fracture or plate deformation easily occurs, and the load-bearing capacity is low. For another example, in the invention patent of a track sliding plate for a vehicle-mounted storage box No. CN206870962U, only a C-shaped roller slot is used to be combined with a roller. Based on this, the structural design of a traditional movable drawer sliding rail is used. Through separate arrangement of a track sliding plate and in conjunction with two rows of roller slots and two rows of rollers, the movable drawer drives the track sliding plate to slide out after the movable drawer is pulled to a certain extent, and a shock absorption bar is also arranged to play a role of shock absorption, so that the roller slots and rollers can achieve high-strength, stable, and reliable pulling even they are not in completely close fit. However, by the adoption of the structure similar to a sliding plate of the movable drawer, a separate plate is used as the track sliding plate, the structural complexity of which will be greatly increased. Moreover, a thickness between the movable drawer and a movable drawer bearing fixing plate will increase. In a case that a space in the trunk of the vehicle is fixed, the storage capacity of the movable drawer will decrease. In addition, when the track sliding plate is assembled, there is a problem of a high requirement for the assembling accuracy. In order to achieve coupling between a track and a roller, a special tool and a technician are required for debugging and assembling. The movable drawer bearing fixing plate and the movable drawer need to be assembled before leaving the factory, which is not suitable for buyers to assemble the drawer by themselves. This will result in high packaging and transportation costs and will bring about a large space occupied by the inventory to manufacturers or intermediaries. However, with the rapid development of times, considering the transportation cost, the packaging cost, and the inventory cost, the movable storage drawer will be gradually developed towards a trend that customers can assemble the drawer by themselves.

The prior art adopts an assembled vehicle-mounted storage box as described in the invention patent No. CN204354930U, which is assembled through cooperation between tenons and tenon slots. Various plates can be assembled and mounted one by one according to a product mounting diagram. Due to a small size and light weight of each plate, a user can easily and conveniently complete the mounting of the vehicle-mounted storage box, thus saving the storage and transportation spaces and costs and facilitating mounting and use. However, the plates used in this type of vehicle-mounted storage box are all made of plastic or wood. The tenon and tenon slot structures can only be manufactured on a plate with a certain thickness. As a result, the entire plate has a large thickness, and many materials are used. Moreover, during the design of a sliding rail structure, if a plate has insufficient rigidity, the accuracy and stability of cooperation of the track structure will be affected due to the aging of the material after use for a period of time, causing the storage box to become loose. In response to this problem, the inventor has proposed a vehicle-mounted storage box as described in the invention No. CN204354929U. An annular groove is formed in an outer circumferential ledge of a guide wheel, and a guide rail is provided with a convex bar embedded in the annular groove. The annular groove matches the convex bar in shape. In addition, a cross section of the annular groove and a cross section of the convex bar are both semicircular. The structural design of the semicircular convex bar at a contact portion between the guide rail described above and the guide wheel and the overall structural design achieve close fit between the guide wheel and the guide rail. However, in this structure the guide wheel needs to be fixed using a mounting member. In order to achieve highly close fit, high-precision cooperation is required between the mounting member and a side plate. Generally, special assembling can only be performed in a production assembly workshop. Moreover, due to a large number of guide wheels, each guide wheel needs to be provided with two mounting members, causing high consumable costs and assembly costs. In addition, since upper and lower parts of the guide wheels are in close fit with the guide rail, and rolling directions of upper and lower ends of the guide wheels are opposite, sliding friction occurs between one of the upper and lower ends of each guide wheel and the guide rail in a pulling process. That is, closer fit between the guide wheels and the guide rail leads to higher resistance generated by the sliding friction, Therefore, in practical applications, the guide wheels and the guide rail cannot achieve completely close fit, and there may still be a gap causing up-and-down shaking in the pulling process. Thus, it is necessary to propose a vehicle-mounted movable drawer structure with high rigidity, light weight, high assembling coupling degree, and good usage stability.

### SUMMARY

In order to overcome the drawbacks described above, the present disclosure aims to provide a technical solution capable of solving the above problems.

A drawer track combining extruded aluminum profiles and spherical bearings includes a movable sliding rail plate and a bearing fixing plate which are mutually guided and are in sliding fit, wherein the movable sliding rail plate and the bearing fixing plate are both made of extruded aluminum profiles; a hollow sliding rail is extruded and formed on one side of the movable sliding rail plate, and curved slideways are formed by inward sinking along an upper part and a lower part of the hollow sliding rail; the bearing fixing plate is rotatably connected with a plurality of outer spherical bearings corresponding to the curved slideways; the bearing fixing plate is extruded to form a thickened bar; the outer spherical bearings are rotatably connected to the thickened bar; the outer spherical bearings have outer spherical surfaces in close fit with the curved slideways; and the bearing fixing plate and the movable sliding rail plate are in guiding and sliding fit with each other through the outer spherical bearings and the hollow sliding rail.

Preferably, a cross section of the thickened bar is of an isosceles trapezoid structure. Preferably, reinforcing ribs abutted with middle positions of the two curved slideways are extruded and formed inside the hollow sliding rail.

Preferably, CNC through holes penetrating through the bearing fixing plate are formed in positions, corresponding to the outer spherical bearings, on the thickened bar; T-nuts are connected to positions, corresponding to the CNC through holes, on the bearing fixing plate; bushings resisting against the thickened bar sleeve the T-nuts; the T-nuts are in threaded connection with fastening screws; and the outer spherical bearings are fixedly mounted on the T-nuts through the fastening screws and the bushings.

Preferably, the outer spherical bearings are deep groove ball bearings; the outer spherical bearings form inner contours and outer contours which are in movable fit with each other through deep groove balls; the outer spherical surfaces are arranged on outer surfaces of the outer contours; the inner contours sleeve the T-shaped nuts; and the inner contours are pressed between the fastening screws and the bushings.

A vehicle-mounted storage drawer combining extruded aluminum profiles and spherical bearings includes the drawer track combining the extruded aluminum profiles and the spherical bearings described above, and includes a fixed frame, a movable drawer, and a movable upper cover, wherein frame side plates are arranged on a left side and a right side of the fixed frame; drawer side plates in sliding fit with the frame side plates are arranged on a left side and a right side of the movable drawer; upper cover side plates in sliding fit with the frame side plates are arranged on a left side and a right side of the movable upper cover; other surfaces of the fixed frame, other surfaces of the movable drawer, and other surfaces of the movable upper cover are made of bent profiles; the frame side plates are made of bearing fixing plates, and the drawer side plates and the upper cover side plates are made of sliding rail movable plates, so that the fixed frame is in guiding and sliding fit with the movable drawer and the movable upper cover respectively through the drawer track; and the fixed frame, the movable drawer, and the movable upper cover are coupled and assembled through the extruded aluminum profiles and the bent profiles.

Preferably, the movable drawer further includes a drawer back plate, a drawer bottom plate, and a drawer panel; four edges of the drawer bottom plate are bent downwards to form first coupling edges; lower parts of the drawer side plates are extruded to form positioning slots corresponding to the first coupling edges; the drawer side plates are screwed to the first coupling edges of the left and right sides of the drawer bottom plate through the positioning slots; lower ends of both the drawer back plate and the drawer bottom plate are screwed to the first coupling edges of the front and rear sides of the drawer bottom plate; first fixing edges are arranged on left and right sides of both the drawer panel and the drawer back plate; the drawer panel and the drawer back plate are both screwed to the drawer side plates through the first fixing edges; upper ends of both the drawer panel and the drawer back plate are bent to be provided with limiting edges; upper ends of the drawer side plates are extruded to form first positioning edges resisting against the limiting edges; and the drawer side plates resist against two ends of the limiting edges through the first positioning edges.

Preferably, the left and right sides of the drawer back plate are bent to form the first fixing edges; the first fixing edges on the drawer panel are welded; the left and right sides of the drawer panel are also respectively bent to be provided with second fixing edges; positioning gaps are formed in middle parts of the second fixing edges; and the second fixing edges are abutted with the hollow sliding rail on the drawer side plates through the positioning gaps in a positioned manner.

Preferably, the fixed frame further includes a frame back plate and a frame cross beam; lower parts of the frame side plates are extruded to form second positioning edges; the frame side plates are screwed to the frame cross beam through the second positioning edges; rear parts of the frame side plates are welded with fixing battens; and the frame back plate is screwed to the fixing battens.

Preferably, an upper end and a lower end of the frame back plate are bent to be provided with second coupling edges; upper ends of the frame side plates are also extruded to form resisting edges; and the frame back plate is coupled and fixed with the second positioning edges and the resisting edges through the second coupling edges.

Preferably, the movable upper cover further includes an upper cover cross beam and an upper cover panel; the upper cover side plates are extruded to form third positioning edges; the upper cover side plates are screwed to the upper cover cross beam through the third positioning edges; the upper cover side plates are also extruded to form pressing edges; the upper cover panel is screwed to the third positioning edges; and the upper cover panel is also limited between the pressing edges and the third positioning edges.

Preferably, upper ends of the upper cover side plates are also extruded to form T-chutes for mounting auxiliary devices.

Preferably, the frame side plates have drawer abutting plates corresponding to the movable drawer, upper cover abutting plates corresponding to the movable upper cover, and transition transverse plates integrally connected between the drawer abutting plates and the upper cover abutting plates, so that the upper cover side plates are abutted to outer sides of the frame side plates, and the drawer side plates are abutted to inner sides of the frame side plates.

Preferably, three rows of outer spherical bearings are arranged on an inner side of the drawer abutting plate; one row of outer spherical bearings are arranged on an outer side of the upper cover abutting plate; CNC permeation holes are formed in the transition transverse plates; and the top row of outer spherical bearings on the drawer abutting plate penetrate through the transition transverse plates along the CNC permeation holes.

Compared with the prior art, the present disclosure has the beneficial effects below:

The side plates made of the extruded aluminum profiles can achieve higher accuracy and higher rigidity. The side plates are then combined with the outer spherical bearings and the hollow sliding rail with the structures of the curved slideways to form the drawer track structure. Furthermore, two rows of spherical bearings resist against the hollow sliding rail, the highly close fit between the outer spherical bearings and the hollow sliding rail is ensured, thereby ensuring the stability of operation of the drawer track and achieving the purposes of high rigidity and light weight. Based on this, the extruded aluminum profiles and the bent aluminum plates cooperate with each other to offset to a certain extent a subtle tolerance generated in an assembling process through the bending deformation of the bent profiles themselves, thereby ensuring the fastening and stability of fit between the extruded aluminum profiles of the drawer track. A certain positioning and correction structure is arranged in conjunction with the drawer back plate, the drawer bottom plate, and the drawer panel to achieve automatic alignment during the assembling, thereby achieving the design purpose of fool-style assembling and guaranteeing the stability of operation of the drawer track. The weight of the drawer is less than that of an iron drawer, so that the fixed framework, the movable drawer, and the movable panel can be sold to a customer separately, so as to achieve the purposes of facilitating transportation, reducing the packaging cost, and reducing the inventory cost.

The drawer track is arranged using the close fit between an aluminum extrusion process and the curved structures. The sliding rail movable plate and the bearing fixed plate are arranged using the aluminum extrusion process. Compared with a bent profile, a profile manufactured by the aluminum extrusion process has greatly improved accuracy and sufficient rigidity, and is not easy to deform, which can ensure the accuracy of sliding of two sides of the vehicle-mounted storage drawer. The hollow sliding rail is synchronously formed on the sliding rail movable plate in an aluminum extrusion manner. The arrangement of the hollow sliding rail can play a role of saving materials, maintaining the shape of the outer surface, and maintaining the rigidity. Furthermore, the hollow sliding rail can have certain elastic coupling performance. The outer spherical bearings are arranged on the bearing fixing plate to cooperate with the hollow sliding rail, so that such a phenomenon that it is hard to push the drawer because of high extrusion force during the close fit between the outer spherical bearings and the hollow sliding rails is avoided. At the same time, it also ensures the closeness of the fit between the outer spherical bearings and the hollow sliding rail.

The outer spherical bearings have outer spherical surfaces that are in close fit with the curved slideways on the hollow sliding rail, and the outer spherical bearings are abutted to the upper and lower ends of the hollow sliding rail, so that the hollow sliding rail can be limited between the two rows of outer spherical bearings. Through this setting, each outer spherical bearing only has this part that is in close fit with the hollow sliding rail. Compared to the structural design of the prior art, the present disclosure can ensure the closeness between the outer spherical bearings and the hollow sliding rail, and there will be no sliding friction or dead lock. The outer spherical bearings can be fastened to the curved slideways on the hollow sliding rail upwards and downwards, so the vehicle-mounted storage drawer will not move left and right. Compared to a planar track of the traditional vehicle-mounted storage drawer, the drawer track of the present disclosure does not have a horizontal positioning mechanism and a debugging program for the horizontal positioning mechanism. The bearing fixing plate is also synchronously extruded to form the thickened bar through the aluminum extrusion process, so that the rigidity between the outer spherical bearings and the bearing fixing plate after the outer spherical bearings are fixed on the thickened bar can be improved, thereby ensuring the rigidity and stability of the sliding fit between the sliding rail movable plate and the bearing fixing plate.

Since positioning structures are manufactured on the drawer back plate, the drawer bottom plate, the drawer panel, the frame back plate, the frame cross beam, the upper cover cross beam, and the upper cover panel by using bent plates and a bending process, all the profiles other than the extruded aluminum profiles can be fixedly connected according to the extruded aluminum profiles. The fixed connection is achieved by screwing. That is, fixed mounting is performed by the cooperation between the bent profiles and the extruded aluminum profiles. In the screw locking process, the bent profiles can have a certain elastic deformation, that is, the bent profiles and the extruded aluminum profiles can achieve a certain degree of assembling coupling during the fixed mounting, thereby ensuring that the extruded aluminum profiles on the drawer back plate, the drawer bottom plate, and the drawer panel can be in precise fit with each other. In order to ensure the accuracy of mounting, mounting will be assisted according to the positioning structures in the mounting process. A buyer can quickly complete the assembling with a screwdriver.

The additional aspects and advantages of the present disclosure will be partially provided in the following descriptions, some of which will become apparent from the following descriptions, or learned through the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic diagram of an assembled structure of a drawer sliding rail in the present disclosure;

FIG. 2 is a schematic diagram of a split structure of a drawer sliding rail in the present disclosure;

FIG. 3 is a schematic structural diagram of an outer spherical bearing in the present disclosure;

FIG. 4 is a schematic structural diagram of a frame side plate, a drawer side plate, and an upper cover side plate in the present invention;

FIG. 5 is a schematic structural diagram of a vehicle-mounted storage drawer in the present disclosure;

FIG. 6 is a schematic structural diagram of a usage state of a vehicle-mounted storage drawer in the present disclosure;

FIG. 7 is a schematic structural diagram of a fixed frame in the present disclosure;

FIG. 8 is a schematic structural diagram of a movable drawer in the present disclosure;

FIG. 9 is a schematic diagram of an exploded structure of a movable drawer in the present disclosure;

FIG. 10 is a schematic structural diagram of a movable upper cover in the present disclosure; and

FIG. 11 is a schematic diagram of an exploded structure of a movable upper cover in the present disclosure.

Reference numerals and names in the drawings are as follows:
sliding rail movable plate 10, hollow sliding rail 11, curved slideway 12, reinforcing rib 13, bearing fixing plate 20, outer spherical bearing 21, thickened bar 22, T-nut 23, bushing 24, fastening screw 25, fixed frame 30, frame side plate 31, drawer abutting plate 311, upper cover abutting plate 312, transition transverse plate 313, CNC permeation hole 314, second positioning edge 315, fixing batten 316, resisting edge 317, frame back plate 32, second coupling edge 321, frame cross beam 33, movable drawer 40, drawer side plate 41, positioning slot 411, first positioning edge 412, drawer back plate 42, drawer bottom plate 43, first coupling edge 431, drawer panel 44, second fixing edge 442, positioning gap 443, first fixing edge 45, limiting edge 46, movable upper cover 50, upper cover side plate 51, third positioning edge 511, pressing edge 512, T-chute 513, upper cover cross beam 52, upper cover panel 53, plywood 531, flocked blanket 532, and nonwoven fabric 533.

### DETAILED DESCRIPTION OF THE EMBODIMENTS

The technical solutions in the embodiments of the present disclosure are clearly and completely described below. Apparently, the described embodiments are merely some embodiments of the present disclosure, rather than all of the embodiments. All other embodiments obtained by a person of ordinary skill in the art based on the embodiments of present disclosure without making creative efforts shall fall within the protection scope of present disclosure.

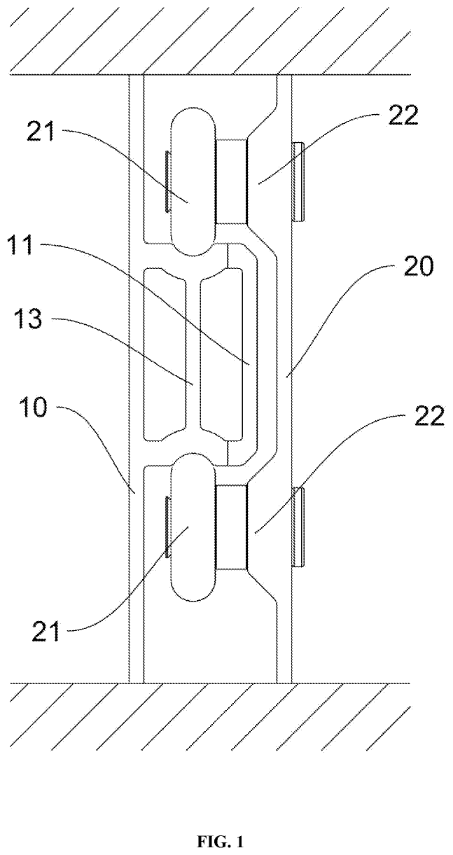

Referring to FIG. 1 to FIG. 3, in the embodiments of the present disclosure, a drawer track combining extruded aluminum profiles and spherical bearings includes a movable sliding rail plate 10 and a bearing fixing plate 20 which are mutually guided and are in sliding fit; the movable sliding rail plate 10 and the bearing fixing plate 20 are both made of extruded aluminum profiles; a hollow sliding rail 11 is extruded and formed on one side of the movable sliding rail plate 10, and curved slideways 12 are formed by inward sinking along an upper part and a lower part of the hollow sliding rail 11; the bearing fixing plate 20 is rotatably connected with a plurality of outer spherical bearings 21 corresponding to the curved slideways 12; the bearing fixing plate 20 is extruded to form a thickened bar 22; the outer spherical bearings 21 are rotatably connected to the thickened bar 22; the outer spherical bearings 21 have outer spherical surfaces in close fit with the curved slideways 12; and the bearing fixing plate 20 and the movable sliding rail plate 10 are in guiding and sliding fit with each other through the outer spherical bearings 21 and the hollow sliding rail 11.

In the above technical solution, the drawer track is arranged using the close fit between an aluminum extrusion process and the curved structures. The sliding rail movable plate 10 and the bearing fixed plate 20 are arranged using the aluminum extrusion process. Compared with a bent profile, a profile manufactured by the aluminum extrusion process has greatly improved accuracy and sufficient rigidity, and is not easy to deform, which can ensure the accuracy of sliding of two sides of the vehicle-mounted storage drawer. Based on the extruded aluminum profiles, the hollow sliding rail 11 is synchronously formed on the sliding rail movable plate in an aluminum extrusion manner. The arrangement of the hollow sliding rail 11 can play a role of saving materials, maintaining the shape of the outer surface, and maintaining the rigidity. In addition, the outer spherical bearings 21 are arranged on the bearing fixing plate 20 to cooperate with the hollow sliding rail 11. The outer spherical bearings 21 have outer spherical surfaces that are in close fit with the curved slideways 12 on the hollow sliding rail 11, and the outer spherical bearings 21 are abutted to the upper and lower ends of the hollow sliding rail 11, so that the hollow sliding rail 11 can be limited between two rows of outer spherical bearings 21. Through this setting, each outer spherical bearing 21 only has this part that is in close fit with the hollow sliding rail 11. Compared to the structural design of the prior art, the present disclosure can ensure the closeness between the outer spherical bearings 21 and the hollow sliding rail 11, and there will be no sliding friction or dead lock. The outer spherical bearings 21 can be fastened to the curved slideways 12 on the hollow sliding rail 11 upwards and downwards, so the vehicle-mounted storage drawer will not move left and right. Compared to a planar track of the traditional vehicle-mounted storage drawer, the drawer track of the present disclosure does not have a horizontal positioning mechanism and a debugging program for the horizontal positioning mechanism. The bearing fixing plate 20 is also synchronously extruded to form the thickened bar 22 through the aluminum extrusion process, so that the rigidity between the outer spherical bearings 21 and the bearing fixing plate 20 after the outer spherical bearings 21 are fixed on the thickened bar 22 can be improved, thereby ensuring the rigidity and stability of the sliding fit between the sliding rail movable plate 10 and the bearing fixing plate 20.

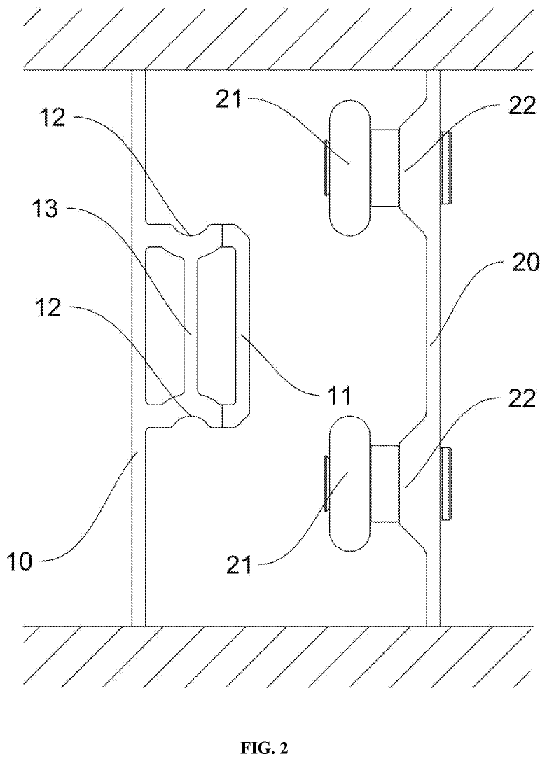

Referring to FIG. 1 to FIG. 2, a cross section of the thickened bar 22 is of an isosceles trapezoid structure, so that a surface parallel to the bearing fixing plate 20 can be formed on the thickened bar 22 to precisely and stably mount the outer spherical bearings 21. When a used drawer has a large height, in order to ensure stable force application in the overall pulling process, a spacing between the two rows of outer spherical bearings 21 that are in fit with the hollow sliding rail 11 needs to be large enough, or a plurality of groups of hollow sliding rails 11 need to be arranged to cooperate with the outer spherical bearings 21. In a case that there is one hollow sliding rail 11, a certain spacing should be ensured between the two rows of spherical bearings, but the hollow sliding rail 11 easily inwards sinks or outwards protrudes due to an acting force of the outer spherical bearings 21. Therefore, in this embodiment, reinforcing ribs 13 respectively abutted to middle positions of the two curved slideways 12 are extruded and formed inside the hollow sliding rail 11. The reinforcing ribs 13 are used to be integrally connected to the curved slideways 12 at the upper and lower positions of the hollow sliding rail 11, which can improve the strength of the curved slideways 12 and ensure that the hollow sliding rail 11 will not inward sink due to the acting force of the outer spherical bearings 21.

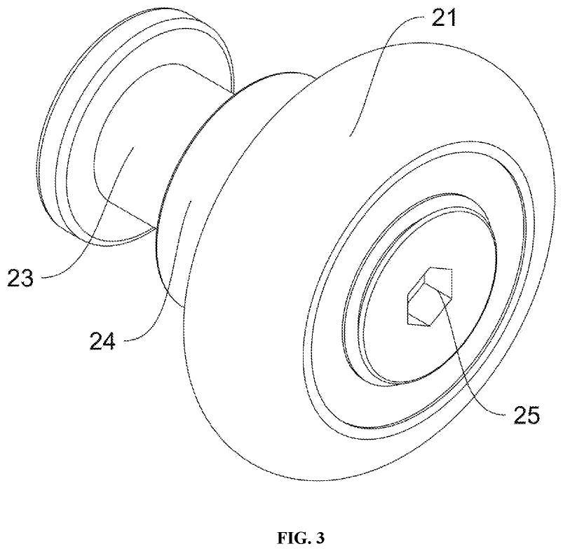

Referring to FIG. 3, based on the fixed mounting manner of the outer spherical bearings 21, in this embodiment, CNC through holes penetrating through the bearing fixing plate 20 are formed in positions, corresponding to the outer spherical bearings 21, on the thickened bar 22; T-nuts 23 are connected to positions, corresponding to the CNC through holes, on the bearing fixing plate 20; bushings 24 resisting against the thickened bar 22 sleeve the T-nuts 23; the T-nuts 23 are in threaded connection with fastening screws 25; and the outer spherical bearings 21 are fixedly mounted on the T-nuts 23 through the fastening screws 25 and the bushings 24. That is, parts for fixedly mounting the outer spherical bearings 21 are composed of the T-nuts 23, the bushings 24, and the fastening screws 25. Rodlike structures of the T-nuts 23 are used to sleeve the bushings 24 and the outer spherical bearings 21. The bushings 24 are configured to separate the outer spherical bearings 21 from the thickened bar 22 and prevent wear of the bearing fixing plate 20 or the outer spherical bearings 21 due to sliding friction occurring between the outer spherical bearings 21 and the thickened bar 22. After sleeving the outer spherical bearings 21, the bushings are fixed by the fastening screws 25, ensuring the firmness of fixing of the outer spherical bearings 21. The assembling manner is simple. The assembly manner may be that components can be assembled in advance in a workshop, or a buyer can assemble components by themselves. Based on the arrangement of the outer spherical bearings 21, the outer spherical bearings 21 used in this embodiment are deep groove ball bearings; the outer spherical bearings 21 form inner contours and outer contours which are in movable fit with each other through deep groove balls; the outer spherical surfaces are arranged on outer surfaces of the outer contours; the inner contours sleeve the T-shaped nuts 23; and the inner contours are pressed between the fastening screws 25 and the bushings 24. This ensures the rigidity in the overall sliding fit process.

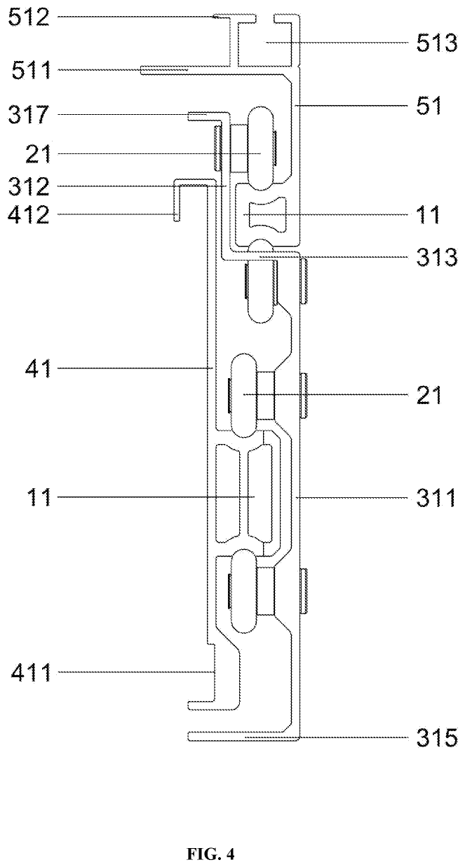

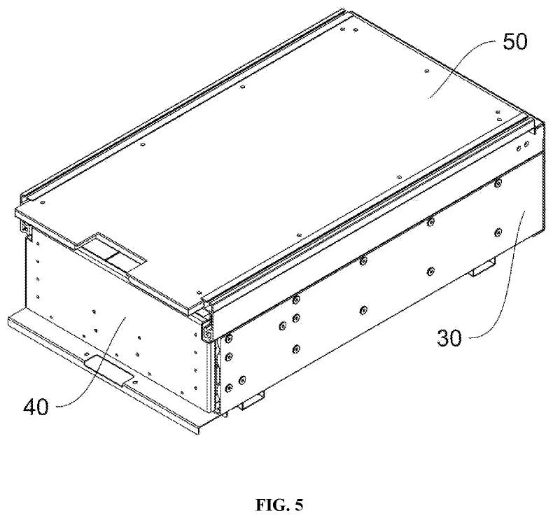

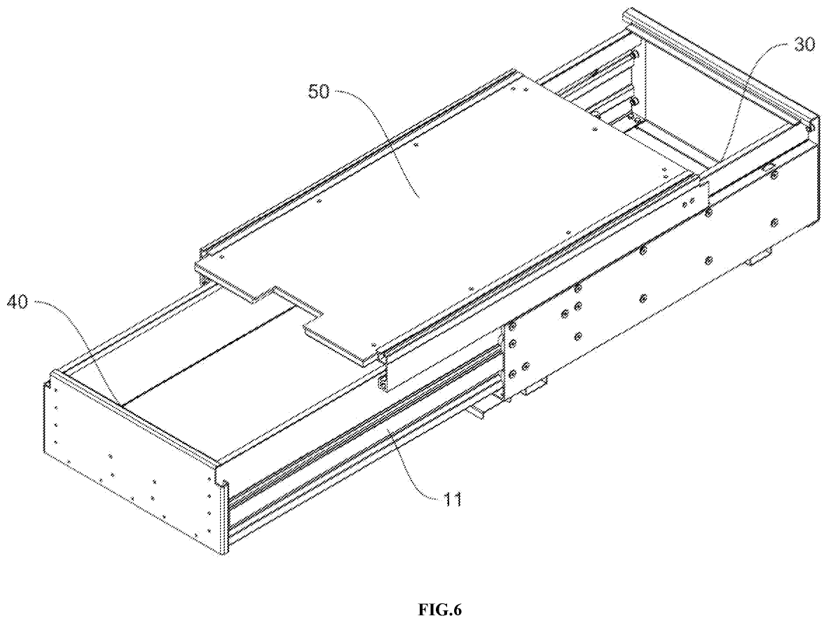

Referring to FIG. 4 to FIG. 11, the drawer track structure combining the extruded aluminum profiles and the spherical bearings will be used to configure a vehicle-mounted storage drawer combining extruded aluminum profiles and spherical bearings. The vehicle-mounted storage drawer includes a fixed frame, 30 a movable drawer 40, and a movable upper cover 50, wherein frame side plates 31 are arranged on a left side and a right side of the fixed frame 30; drawer side plates 41 in sliding fit with the frame side plates 31 are arranged on a left side and a right side of the movable drawer 40; upper cover side plates 51 in sliding fit with the frame side plates 31 are arranged on a left side and a right side of the movable upper cover 50; other surfaces of the fixed frame 30, other surfaces of the movable drawer 40, and other surfaces of the movable upper cover 50 are made of bent profiles; the frame side plates 31 are made of bearing fixing plates 20, and the drawer side plates 41 and the upper cover side plates 51 are made of sliding rail movable plates 10, so that the fixed frame 30 is in guiding and sliding fit with the movable drawer 40 and the movable upper cover 50 respectively through the drawer track; and the fixed frame 30, the movable drawer 40, and the movable upper cover 50 are coupled and assembled through the extruded aluminum profiles and the bent profiles. The vehicle-mounted storage drawer is divided into three parts: the fixed frame 30, the movable drawer 40, and the movable upper cover 50. The fixed frame 30 is fixedly mounted in a trunk of a vehicle. The movable drawer 40 and the movable upper cover 50 are respectively connected to the fixed frame 30 in a pulling type sliding manner. Two sides of the fixed frame 30, two sides of the movable drawer 40, and two sides of the movable upper cover 50 are all made of extruded aluminum profiles. Side parts of the movable drawer 40 and side parts of the movable upper cover 50 are made of the sliding rail movable plate 10, and side parts of the fixed frame 30 are made of the bearing fixing plate 20. The drawer track structure among the fixed frame 30, the movable drawer 40, and the movable upper cover 50 is configured using the extruded aluminum profiles, thus ensuring the accuracy of structural fit. Due to a high requirement for the difficulty of the aluminum extrusion process, in order to save materials and lower the production and manufacturing difficulty, other surfaces of the fixed frame 30, other surfaces of the movable drawer 40, and other surfaces of the movable upper cover 50 are made of bent profiles.

Referring to FIG. 4 to FIG. 11, the movable drawer 40 further includes a drawer back plate 42, a drawer bottom plate 43, and a drawer panel 44; the fixed frame 30 further includes a frame back plate 32 and a frame cross beam 33; and the movable upper cover 50 further includes an upper cover cross beam 52 and an upper cover panel 53. In order to guarantee the accuracy, a CNC processing technology needs to be used. Through this fit manner, use of both the CNC through holes and the aluminum extrusion process can guarantee the accuracy of sizes of the sliding rail movable plate 10 and the bearing fixing plate 20. Therefore, the left and right fitting distances between the fixed frame 30, the movable drawer 40, and the movable upper cover 50 needs to be considered for assembling. Since positioning structures are manufactured on the drawer back plate 42, the drawer bottom plate 43, the drawer panel 44, the frame back plate 32, the frame cross beam 33, the upper cover cross beam 52, and the upper cover panel 53 by using bent plates and a bending process, all the profiles other than the extruded aluminum profiles can be fixedly connected according to the extruded aluminum profiles. In order to ensure the accuracy of mounting, mounting will be assisted according to the positioning structures in the mounting process. The fixed connection is achieved by screwing. A buyer can quickly complete the assembling with a screwdriver. That is, fixed mounting is performed by the cooperation between the bent profiles and the extruded aluminum profiles. In the screw locking process, the bent profiles can have a certain elastic deformation, that is, the bent profiles and the extruded aluminum profiles can achieve a certain degree of assembling coupling during the fixed mounting, thereby ensuring that the extruded aluminum profiles on the drawer back plate 42, the drawer bottom plate 43, and the drawer panel 44 can be in precise fit with each other.

Referring to FIG. 4 to FIG. 11, the vehicle-mounted storage drawer mainly includes the three parts: the fixed frame 30, the movable drawer 40, and the movable upper cover 50. A positional relationship among the frame side plates 31, the drawer side plates 41, and the upper cover side plates 51 are set as follows: The frame side plates 31 are arranged in the middle, while the drawer side plates 41 and the upper cover side plates 51 respectively correspond to the inner sides and outer sides of the frame side plates 31 to make the overall structure firmer and more reliable. The firmness and stability of the overall fit are guaranteed by the fitting manner between the frame side plates 31, the drawer side plates 41, and the upper cover side plates 51. The frame side plates 31 are configured to have drawer abutting plates 311 corresponding to the movable drawer 40, upper cover abutting plates 312 corresponding to the movable upper cover 50, and transition transverse plates 313 integrally connected between the drawer abutting plates 311 and the upper cover abutting plates 312, so that the upper cover side plates 51 are abutted to outer sides of the frame side plates 31, and the drawer side plates 41 are abutted to inner sides of the frame side plates 31. Through this structural configuration, the tidiness of the overall appearance of the vehicle-mounted storage drawer can also be guaranteed. In addition, since the movable upper cover 50 only plays a closing role, the upper cover side plates 51 do not need to be configured to be too wide. If the two rows of outer spherical bearings 21 corresponding to the upper cover side plates 51 are arranged on the outer sides of the frame side plates 31, widths of the upper cover abutting plates 312 will increase. At the same time, in order to ensure the integrity of the overall appearance, lower ends of the upper cover side plates 51 also need to be provided with covering edges to cover the lower row of outer spherical bearings 21 abutted to the upper cover side plates 51. This will increase the overall widths of the upper cover side plates 51, thus causing an increase in the material cost. Therefore, three rows of outer spherical bearings 21 are arranged on inner sides of the drawer abutting plates 311; one row of outer spherical bearings 21 are arranged on outer sides of the upper cover abutting plates 312; CNC permeation holes 314 are formed in the transition transverse plates 313; and the top row of outer spherical bearings 21 on the drawer abutting plates 311 penetrate through the transition transverse plates 313 along the CNC permeation holes 314. Through this configuration, the lower row of outer spherical bearings 21 abutted to the upper cover side plates 51 are directly covered by the drawer abutting plates 311, thus ensuring the design of minimum widths of the upper cover side plates 51.

This embodiment makes a further description to a large coupling degree of the assembling of the entire vehicle-mounted storage drawer on the basis of the positioning structures adopted between the fixed frame 30, the movable drawer 40, and the movable upper cover 50. Details are as follows:

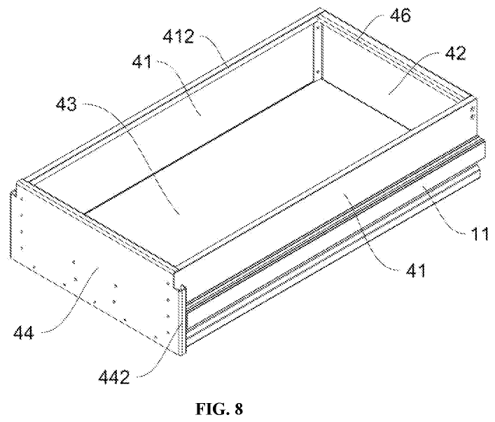

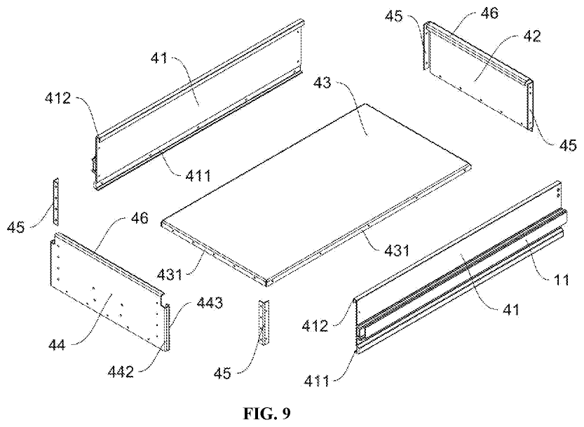

Referring to FIG. 8 to FIG. 9, the movable drawer 40 further includes the drawer back plate 42, the drawer bottom plate 43, and the drawer panel 44; four edges of the drawer bottom plate 43 are bent downwards to form first coupling edges 431; lower parts of the drawer side plates 41 are extruded to form positioning slots 411 corresponding to the first coupling edges 431; the drawer side plates 41 are screwed to the first coupling edges 431 of the left and right sides of the drawer bottom plate 43 through the positioning slots 411. The purpose of high coupling can be achieved. A user can accurately assemble the drawer side plates 41 and the drawer bottom plate 43. Lower ends of both the drawer back plate 42 and the drawer bottom plate 43 are screwed to the first coupling edges 431 of the front and rear sides of the drawer bottom plate 43. First fixing edges 45 are arranged on left and right sides of both the drawer panel 44 and the drawer back plate 42; the drawer panel 44 and the drawer back plate 42 are both screwed to the drawer side plates 41 through the first fixing edges 45; upper ends of both the drawer panel 44 and the drawer back plate 42 are bent to be provided with limiting edges 46; upper ends of the drawer side plates 41 are extruded to form first positioning edges 412 resisting against the limiting edges 46; and the drawer side plates 41 resist against two ends of the limiting edges 46 through the first positioning edges 412.

After the drawer panel 44 and the drawer back plate 42 are roughly screwed, the limiting edges 46 and the first positioning edges 412 are in pressing fit to lock the screws, so that a spacing between the two drawer side plates 41 can be automatically controlled, eliminating a debugging operation performed by a buyer in the assembling process and achieving the purpose of fool-type assembling. The left and right sides of the drawer back plate 42 are bent to form the first fixing edges 45; the first fixing edges 45 on the drawer panel 44 are welded; the left and right sides of the drawer panel 44 are also respectively bent to be provided with second fixing edges 442; positioning gaps 443 are formed in middle parts of the second fixing edges 442; and the second fixing edges 442 are abutted with the hollow sliding rail 11 on the drawer side plates 41 through the positioning gaps 443 in a positioned manner. Through this configuration, the accuracy of the positioning fit between the drawer panel 44 and the drawer side plates 41 can be improved, and the drawer side plates 41 can be covered to a certain extent to ensure the compactness of the overall front surface, without affecting the visual effect due to spacings generated between the drawer side plates 41 and the frame side plates 31 caused by the hollow sliding rail 11.

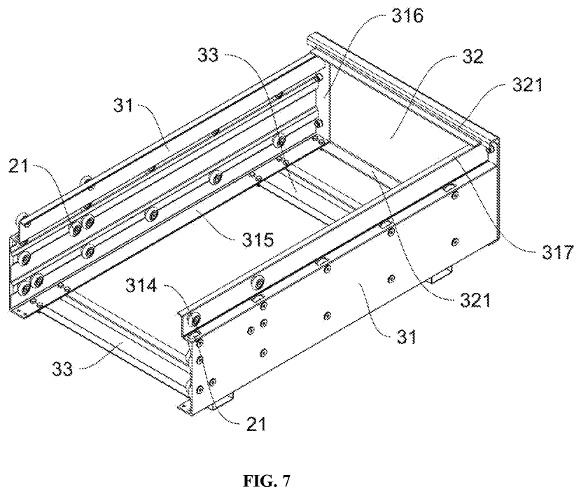

Referring to FIG. 7, the fixed frame 30 further includes the frame back plate 32 and the frame cross beam 33; lower parts of the frame side plates 31 are extruded to form second positioning edges 315; the frame side plates 31 are screwed to the frame cross beam 33 through the second positioning edges 315; rear parts of the frame side plates 31 are welded with fixing battens 316; and the frame back plate 32 is screwed to the fixing battens 316. That is, the frame back plate 32 and the frame cross beam 33 are screwed to the frame side plates 31 on the basis of no bending in their widths. The overall mounting accuracy can be guaranteed as long as empty processing of screwing is accurate (CNC processing is adopted). Due to the aluminum extrusion process, flat surfaces cannot be arranged on the front and back parts of the frame side plates 31. Therefore, the fixing battens 316 are welded at the rear parts of the frame side plates 31, which can also achieve accurate fit. An upper end and a lower end of the frame back plate 32 are bent to be provided with second coupling edges 321; upper ends of the frame side plates 31 are also extruded to form resisting edges 317; and the frame back plate 32 is coupled and fixed with the second positioning edges 315 and the resisting edges 317 through the second coupling edges 321. The second coupling edges 321 can play a positioning role in the assembling process and can also guarantee the strength of the frame back plate 32, so that the frame back plate is not easy to bend or deform.

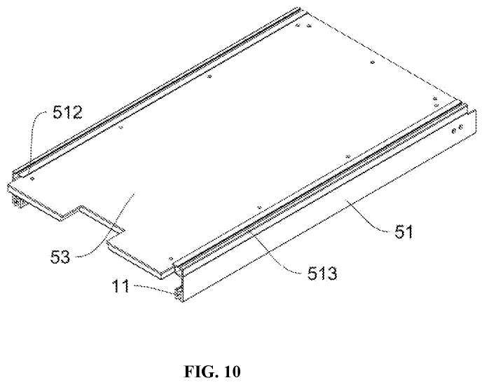

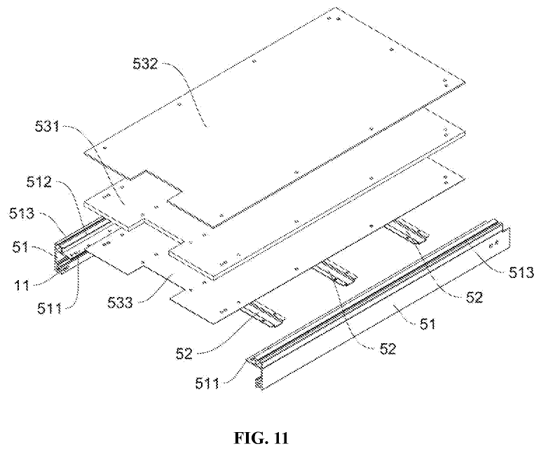

Referring to FIG. 10 to FIG. 11, the movable upper cover 50 further includes the upper cover cross beam 52 and the upper cover panel 53; the upper cover side plates 51 are extruded to form third positioning edges 511; the upper cover side plates 51 are screwed to the upper cover cross beam 52 through the third positioning edges 511; the upper cover side plates 51 are also extruded to form pressing edges 512; the upper cover panel 53 is screwed to the third positioning edges 511; and the upper cover panel 53 is also limited between the pressing edges 512 and the third positioning edges 511. The accuracy of fitting between the upper cover side plates 51 and the upper cover cross beam 52 is guaranteed by no bending in their widths and CNC processing and punching. During the assembling of the upper cover panel 53, the upper cover panel 53 can be plugged and positioned by the fit between the pressing edges 512 and the third positioning edges 511, so that the screwing can be facilitated. A main body of the upper cover panel 53 is made of a plywood 531; a top surface is covered with a flocked blanket 532; and a bottom surface is covered with a nonwoven fabric 533. Upper ends of the upper cover side plates 51 are also extruded to form T-chutes 513 for mounting auxiliary devices. The T-chutes 513 can be connected to some supporting rods, hooks, or similar objects through the T-nuts, so that an object can be reinforced by a rope after being placed in the vehicle-mounted storage drawer.

Based on the configuration of the vehicle-mounted storage drawer described above, the side plates made of the extruded aluminum profiles can achieve higher accuracy and higher rigidity. The side plates are then combined with the outer spherical bearings 21 and the hollow sliding rail 11 with the structures of the curved slideways 12 to form the drawer track structure. Furthermore, two rows of spherical bearings resist against the hollow sliding rail 11, so that the highly close fit between the outer spherical bearings 21 and the hollow sliding rail 11 is ensured, thereby ensuring the stability of operation of the drawer track and achieving the purposes of high rigidity and light weight. Based on this, the extruded aluminum profiles and the bent profiles cooperate with each other to offset to a certain extent a subtle tolerance generated in an assembling process through the bending deformation of the bent profiles themselves, thereby ensuring the fastening and stability of fit between the extruded aluminum profiles of the drawer track. A certain positioning and correction structure is arranged in conjunction with the drawer back plate 42, the drawer bottom plate 43, and the drawer panel 44 to achieve automatic alignment during the assembling, thereby achieving the design purpose of fool-style assembling. Thus, the fixed framework 30, the movable drawer 40, and the movable panel can be sold to a customer separately, so as to achieve the purposes of facilitating transportation, reducing the packaging cost, and reducing the inventory cost.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure.

What is claimed is:

1. A drawer track combining extruded aluminum profiles and spherical bearings, comprising a movable sliding rail plate and a bearing fixing plate which are mutually guided and are in sliding fit, wherein the movable sliding rail plate and the bearing fixing plate are both made of extruded aluminum profiles; a hollow sliding rail is extruded and formed on one side of the movable sliding rail plate, and curved slideways are formed by inward sinking along an upper part and a lower part of the hollow sliding rail; the bearing fixing plate is rotatably connected with a plurality of outer spherical bearings corresponding to the curved slideways; the bearing fixing plate is extruded to form a thickened bar; the outer spherical bearings are rotatably connected to the thickened bar; the outer spherical bearings have outer spherical surfaces in close fit with the curved slideways; and the bearing fixing plate and the movable sliding rail plate are in guiding and sliding fit with each other through the outer spherical bearings and the hollow sliding rail.

2. The drawer track combining the extruded aluminum profiles and the spherical bearings according to claim 1, wherein a cross section of the thickened bar is of an isosceles trapezoid structure.

3. The drawer track combining the extruded aluminum profiles and the spherical bearings according to claim 1, wherein reinforcing ribs abutted with middle positions of the two curved slideways are extruded and formed inside the hollow sliding rail.

4. The drawer track combining the extruded aluminum profiles and the spherical bearings according to claim 1, wherein CNC through holes penetrating through the bearing fixing plate are formed in positions, corresponding to the outer spherical bearings, on the thickened bar; T-nuts are connected to positions, corresponding to the CNC through holes, on the bearing fixing plate; bushings resisting against the thickened bar sleeve the T-nuts; the T-nuts are in threaded connection with fastening screws; and the outer spherical bearings are fixedly mounted on the T-nuts through the fastening screws and the bushings.

5. The drawer track combining the extruded aluminum profiles and the spherical bearings according to claim 4, wherein the outer spherical bearings are deep groove ball bearings; the outer spherical bearings form inner contours and outer contours which are in movable fit with each other through deep groove balls; the outer spherical surfaces are arranged on outer surfaces of the outer contours; the inner contours sleeve the T-shaped nuts; and the inner contours are pressed between the fastening screws and the bushings.

6. A vehicle-mounted storage drawer combining extruded aluminum profiles and spherical bearings, comprising the drawer track combining the extruded aluminum profiles and the spherical bearings according to claim 1, and comprising a fixed frame, a movable drawer, and a movable upper cover, wherein frame side plates are arranged on a left side and a right side of the fixed frame; drawer side plates in sliding fit with the frame side plates are arranged on a left side and a right side of the movable drawer; upper cover side plates in sliding fit with the frame side plates are arranged on a left side and a right side of the movable upper cover; other surfaces of the fixed frame, other surfaces of the movable drawer, and other surfaces of the movable upper cover are made of bent profiles; the frame side plates are made of bearing fixing plates, and the drawer side plates and the upper cover side plates are made of sliding rail movable plates, so that the fixed frame is in guiding and sliding fit with the movable drawer and the movable upper cover respectively through the drawer track; and the fixed frame, the movable drawer, and the movable upper cover are coupled and assembled through the extruded aluminum profiles and the bent profiles.

7. The vehicle-mounted storage drawer combining the extruded aluminum profiles and the spherical bearings according to claim 6, wherein the movable drawer further comprises a drawer back plate, a drawer bottom plate, and a drawer panel; four edges of the drawer bottom plate are bent downwards to form first coupling edges; lower parts of the drawer side plates are extruded to form positioning slots corresponding to the first coupling edges; the drawer side plates are screwed to the first coupling edges of the left and right sides of the drawer bottom plate through the positioning slots; lower ends of both the drawer back plate and the drawer bottom plate are screwed to the first coupling edges of the front and rear sides of the drawer bottom plate; first fixing edges are arranged on left and right sides of both the drawer panel and the drawer back plate; the drawer panel and the drawer back plate are both screwed to the drawer side plates through the first fixing edges; upper ends of both the drawer panel and the drawer back plate are bent to be provided with limiting edges; upper ends of the drawer side plates are extruded to form first positioning edges resisting against the limiting edges; and the drawer side plates resist against two ends of the limiting edges through the first positioning edges.

8. The vehicle-mounted storage drawer combining the extruded aluminum profiles and the spherical bearings according to claim 7, wherein the left and right sides of the drawer back plate are bent to form the first fixing edges; the first fixing edges on the drawer panel are welded; the left and right sides of the drawer panel are also respectively bent to be provided with second fixing edges; positioning gaps are formed in middle parts of the second fixing edges; and the second fixing edges are abutted with the hollow sliding rail on the drawer side plates through the positioning gaps in a positioned manner.

9. The vehicle-mounted storage drawer combining the extruded aluminum profiles and the spherical bearings according to claim 6, wherein the fixed frame further comprises a frame back plate and a frame cross beam; lower parts of the frame side plates are extruded to form second positioning edges; the frame side plates are screwed to the frame cross beam through the second positioning edges; rear parts of the frame side plates are welded with fixing battens; and the frame back plate is screwed to the fixing battens.

10. The vehicle-mounted storage drawer combining the extruded aluminum profiles and the spherical bearings according to claim 9, wherein an upper end and a lower end of the frame back plate are bent to be provided with second coupling edges; upper ends of the frame side plates are also extruded to form resisting edges; and the frame back plate is coupled and fixed with the second positioning edges and the resisting edges through the second coupling edges.

11. The vehicle-mounted storage drawer combining the extruded aluminum profiles and the spherical bearings according to claim 6, wherein the movable upper cover further comprises an upper cover cross beam and an upper cover panel; the upper cover side plates are extruded to form third positioning edges; the upper cover side plates are screwed to the upper cover cross beam through the third positioning edges; the upper cover side plates are also extruded to form pressing edges; the upper cover panel is screwed to the third positioning edges; and the upper cover panel is also limited between the pressing edges and the third positioning edges.

12. The vehicle-mounted storage drawer combining the extruded aluminum profiles and the spherical bearings according to claim 11, wherein upper ends of the upper cover side plates are also extruded to form T-chutes for mounting auxiliary devices.

13. The vehicle-mounted storage drawer combining the extruded aluminum profiles and the spherical bearings according to claim 6, wherein the frame side plates have drawer abutting plates corresponding to the movable drawer, upper cover abutting plates corresponding to the movable upper cover, and transition transverse plates integrally connected between the drawer abutting plates and the upper cover abutting plates, so that the upper cover side plates are abutted to outer sides of the frame side plates, and the drawer side plates are abutted to inner sides of the frame side plates.

14. The vehicle-mounted storage drawer combining the extruded aluminum profiles and the spherical bearings according to claim 13, wherein three rows of outer spherical bearings are arranged on an inner side of the drawer abutting plate; one row of outer spherical bearings are arranged on an outer side of the upper cover abutting plate; CNC permeation holes are formed in the transition transverse plates; and the top row of outer spherical bearings on the drawer abutting plates penetrate through the transition transverse plates along the CNC permeation holes.
